(19) United States
(12) Patent Application Publication
(10) Pub. No.: US 2005/0230034 A1
(43) Pub. Date: Oct. 20, 2005

(54) Abrasion resistant, soft nonwoven

(76) Inventors: Kelyn Anne Arora, Cincinnati, OH (US); Douglas Herrin Benson, W. Harrison, IN (US); John Joseph Curro, Cincinnati, OH (US); Anneke Margaret Kaminski, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/147,509

(22) Filed: Jun. 8, 2005

Related U.S. Application Data
(62) Division of application No. 09/955,879, filed on Sep. 19, 2001, now abandoned.
Application No. 09/955,879 is a continuation-in-part of application No. 09/687,458, filed on Oct. 13, 2000, now abandoned.

(51) Int. Cl. B32B 1/00; B32B 31/00

(52) U.S. Cl. 156/229; 156/161

(57) ABSTRACT

A soft, fibrous material having excellent abrasion resistance and superior softness is made by relatively highly consolidating and then incrementally stretching a nonwoven material. The finished material is a nonwoven web having a plurality of discrete, spaced apart relatively high basis weight regions which are at least partially surrounded by at least one relatively low basis weight region. In one embodiment the soft, fibrous material is made from a nonwoven web having a consolidation area of at least about 30%, and the material has a bending rigidity (which correlates to softness) in a machine direction axis of bending of less than about 0.018 g·cm²/cm. In another embodiment, the soft, fibrous material is made from a nonwoven web having a consolidation area of at least about 30%, and the material has a fuzz removal value (which correlates to abrasion resistance) of less than about 0.30 mg/cm².

### CROSS REFERENCE TO RELATED APPLICATION

This is a divisional application of application Ser. No. 09/955,879, filed Sep. 19, 2001, which is a continuation-in-part of application Ser. No. 09/687,458, filed on Oct. 13, 2000.

### FIELD OF THE INVENTION

The present invention relates to nonwoven webs or fabrics. In particular, the present invention relates to nonwoven webs having superior abrasion resistance and excellent softness characteristics.

### BACKGROUND

Nonwoven webs or fabrics are desirable for use in a variety of products such as bandaging materials, garments, disposable diapers, and other personal hygiene products, including pre-moistened wipes. Nonwoven webs having high levels of strength, softness and abrasion resistance are desirable for disposable absorbent garments, such as diapers, incontinence briefs, training pants, feminine hygiene garments, and the like. For example, in a disposable diaper, it is highly desirable to have soft, strong, nonwoven components, such as topsheets or backsheets (also known as outer covers). Topsheets form the inner, body-contacting portion of a diaper which makes softness highly beneficial. Backsheets benefit from the appearance of being cloth-like, and softness adds to the cloth-like perception consumers prefer. Abrasion resistance relates to a nonwoven web's durability, and is characterized by a lack of significant loss of fibers in use.

Abrasion resistance can be characterized by a nonwoven's tendency to “fuzz,” which may also be described as “linting” or “pilling”. Fuzzing occurs as fibers, or small bundles of fibers, are rubbed off, pulled off, or otherwise released from the surface of the nonwoven web. Fuzzing can result in fibers remaining on the skin or clothing of the wearer or others, as well as a loss of integrity in the nonwoven, both highly undesirable conditions for users. Fuzzing can be controlled in much the same way that strength is imparted, that is, by bonding or entangling adjacent fibers in the nonwoven web to one another. To the extent that fibers of the nonwoven web are bonded to, or entangled with, one another, strength can be increased, and fuzzing levels can be controlled.

Softness can be improved by mechanically post treating a nonwoven. For example, by incrementally stretching a nonwoven web by the method disclosed in commonly assigned, co-pending application Ser. No. 09/274,976, filed Mar. 23, 1999, in the names of Dobrin et al., and U.S. Pat. No. 5,626,571, issued May 6, 1997 in the names of Young et al., it can be made soft and extensible, while retaining sufficient strength for use in disposable absorbent articles. Dobrin et al. '976, which is hereby incorporated herein by reference, teaches making a nonwoven web soft and extensible by employing opposed pressure applicators having three-dimensional surfaces which at least to a degree are complementary to one another. Young et al., which is hereby incorporated herein by reference, teaches making a nonwoven web which is soft and strong by permanently stretching an inelastic base nonwoven in the cross-machine direction. However, neither Young et al., nor Dobrin et al., teach the non-fuzzing tendency of their respective nonwoven webs. For example, the method of Dobrin et al. may result in a nonwoven web having a relatively high fuzzing tendency. That is, the soft, extensible nonwoven web of Dobrin et al. has relatively low abrasion resistance, and tends to fuzz as it is handled or used in product applications.

One method of bonding, or “consolidating”, a nonwoven web is to bond adjacent fibers in a regular pattern of spaced, thermal spot bonds. One suitable method of thermal bonding is described in U.S. Pat. No. 3,855,046, issued Dec. 17, 1974 to Hansen et al., which is hereby incorporated herein by reference. Hansen et al. teach a thermal bond pattern having a 10-25% bond area (termed “consolidation area” herein) to render the surfaces of the nonwoven web abrasion resistant. However, even greater abrasion resistance together with increased softness can further benefit the use of nonwoven webs in many applications, including disposable absorbent articles, such as diapers, training pants, feminine hygiene articles, and the like.

By increasing the size of the bond sites, or by decreasing the distance between bond sites, more fibers are bonded, and abrasion resistance can be increased (fuzzing can be reduced). However, the corresponding increase in bond area of the nonwoven also increases the bending rigidity (i.e., stiffness), which is inversely related to a perception of softness (i.e. as bending rigidity increases, softness decreases). In other words, abrasion resistance is directly proportional to bending rigidity when achieved by known methods. Because abrasion resistance correlates to fuzzing, and bending resistance correlates to perceived softness, known methods of nonwoven production require a tradeoff between the fuzzing and softness properties of a nonwoven.

Various approaches have been tried to improve the abrasion resistance of nonwoven materials without compromising softness. For example, U.S. Pat. Nos. 5,405,682 and 5,425,987, both issued to Shawyer et al. teach a soft, yet durable, cloth-like nonwoven fabric made with multicomponent polymeric strands. However, the multicomponent fibers disclosed comprise a relatively expensive elastomeric thermoplastic material (i.e. KRATON®) in one side or the sheath of multicomponent polymeric strands. U.S. Pat. No. 5,336,552 issued to Strack et al. discloses a similar approach in which an ethylene alkyl acrylate copolymer is used as an abrasion resistance additive in multicomponent polyolefin fibers. U.S. Pat. No. 5,545,464, issued to Stokes describes a pattern bonded nonwoven fabric of conjugate fibers in which a lower melting point polymer is enveloped by a higher melting point polymer.

Bond patterns have also been utilized to improve strength and abrasion resistance in nonwovens while maintaining or even improving softness. Various bond patterns have been developed to achieve improved abrasion resistance without too negatively affecting softness. U.S. Pat. No. 5,964,742 issued to McCormack et al. discloses a thermal bonding pattern comprising elements having a predetermined aspect ratio. The specified bond shapes reportedly provide sufficient numbers of immobilized fibers to strengthen the fabric, yet not so much as to increase stiffness unacceptably. U.S. Pat. No. 6,015,605 issued to Tsujiyama et al. discloses very specific thermally press bonded portions in order to deliver strength, hand feeling, and abrasion resistance. However, with all bond pattern solutions it is believed that the essential tradeoff between bond area and softness remains.

Accordingly, there is a continuing unaddressed need for a nonwoven having a sufficiently high percentage of bond area for abrasion resistance, while maintaining sufficiently low bending rigidity, especially in a machine direction, for a desirable perception of softness.

Additionally, there is a continuing unaddressed need for a low fuzzing, soft nonwoven suitable for use as a component in a disposable absorbent article.

Additionally, there is a continuing unaddressed need for a soft, extensible nonwoven web having relatively high abrasion resistance.

Further, there is a continuing unaddressed need for a method of processing a nonwoven such that abrasion resistance is achieved with little or no decrease in softness.

### SUMMARY OF THE INVENTION

A soft, fibrous material having excellent abrasion resistance and superior softness is made by relatively highly consolidating and then incrementally stretching a nonwoven material. The finished material is a nonwoven web having a plurality of discrete, spaced apart relatively high basis weight regions which are at least partially surrounded by at least one relatively low basis weight region. In one embodiment the soft, fibrous material is made from a nonwoven web having a consolidation area of at least about 30%, and the material has a bending rigidity (which correlates to softness) in a machine direction axis of bending of less than about 0.018 g·cm²/cm. In another embodiment, the soft, fibrous material is made from a nonwoven web having a consolidation area of at least about 30%, and the material has a fuzz removal value (which correlates to abrasion resistance) of less than about 0.30 mg/cm2. The relatively high consolidation of the nonwoven can be achieved by multiple passes through a calendar-type thermal bonding apparatus.

### BRIEF DESCRIPTION OF THE DRAWINGS

FIG. 1 is a schematic representation of an apparatus for producing a web of the present invention.

FIG. 2 is a photomicrograph showing a greatly enlarged representative pattern of thermal bond sites in a partially consolidated nonwoven suitable for use in the present invention.

FIG. 3A is a photomicrograph showing a greatly enlarged representative pattern of thermal bond sites in an overbonded (once overbonded) consolidated nonwoven suitable for further processing into a web of in the present invention.

FIG. 3B is a photomicrograph showing a greatly enlarged representative pattern of thermal bond sites in an additionally overbonded (twice overbonded) consolidated nonwoven suitable for further processing into a web of in the present invention.

FIG. 4 is a perspective view of an incremental stretching system.

FIG. 5 is a cross-sectional fragmentary enlarged view of a portion of an incremental stretching system comprising inter-engaging incremental stretching rollers.

FIG. 6 shows a graph of elongation to break for several samples of the web of the present invention.

FIG. 7 is an enlarged view of an alternative incremental stretching system.

FIG. 8 is an enlarged view of another alternative incremental stretching system.

FIG. 9 is a perspective view of a disposable absorbent article having components that can be made of a nonwoven web material of the present invention.

FIG. 10 is a schematic representation of the method of marking and selecting a tensile test sample.

### DETAILED DESCRIPTION OF THE INVENTION

As used herein, the term “absorbent article” refers to devices which absorb and contain body exudates, and, more specifically, refers to devices which are placed against or in proximity to the body of the wearer to absorb and contain the various exudates discharged from the body.

The term “disposable” is used herein to describe absorbent articles which are not intended to be laundered or otherwise restored or reused as an absorbent article (i.e., they are intended to be discarded after a single use and, preferably, to be recycled, composted or otherwise disposed of in an environmentally compatible manner). A “unitary” absorbent article refers to absorbent articles which are formed of separate parts united together to form a coordinated entity so that they do not require separate manipulative parts like a separate holder and liner.

As used herein, the term “nonwoven web”, refers to a web that has a structure of individual fibers or threads which are interlaid, but not in any regular, repeating manner. Nonwoven webs have been, in the past, formed by a variety of processes, such as, for example, air laying processes, meltblowing processes, spunbonding processes and carding processes, including bonded carded web processes.

As used herein, the term “microfibers”, refers to small diameter fibers having an average diameter not greater than about 100 microns. Fibers, and in particular, spunbond fibers utilized in the present invention can be microfibers, or more specifically, they can be fibers having an average diameter of about 15-30 microns, and having a denier from about 1.5-3.0.

As used herein, the term “meltblown fibers”, refers to fibers formed by extruding a molten thermoplastic material through a plurality of fine, usually circular, die capillaries as molten threads or filaments into a high velocity gas (e.g., air) stream which attenuates the filaments of molten thermoplastic material to reduce their diameter, which may be to a microfiber diameter. Thereafter, the meltblown fibers are carried by the high velocity gas stream and are deposited on a collecting surface to form a web of randomly dispersed meltblown fibers.

As used herein, the term “spunbonded fibers”, refers to small diameter fibers which are formed by extruding a molten thermoplastic material as filaments from a plurality of fine, usually circular, capillaries of a spinneret with the diameter of the extruded filaments then being rapidly reduced by drawing.

As used herein, the terms “consolidation” and “consolidated” refer to the bringing together of at least a portion of the fibers of a nonwoven web into closer proximity to form a site, or sites, which function to increase the resistance of the nonwoven to external forces, e.g., abrasion and tensile forces, as compared to the unconsolidated web. “Consolidated” can refer to an entire nonwoven web that has been processed such that at least a portion of the fibers are brought into closer proximity, such as by thermal point bonding. Such a web can be considered a “consolidated web”. In another sense, a specific, discrete region of fibers that is brought into close proximity, such as an individual thermal bond site, can be described as “consolidated”.

Consolidation can be achieved by methods that apply heat and/or pressure to the fibrous web, such as thermal spot (i.e., point) bonding. Thermal point bonding can be accomplished by passing the fibrous web through a pressure nip formed by two rolls, one of which is heated and contains a plurality of raised points on its surface, as is described in the aforementioned U.S. Pat. No. 3,855,046 issued to Hansen et al. Consolidation methods can also include ultrasonic bonding, through-air bonding, and hydroentanglement. Hydroentanglement typically involves treatment of the fibrous web with high pressure water jets to consolidate the web via mechanical fiber entanglement (friction) in the region desired to be consolidated, with the sites being formed in the area of fiber entanglement. The fibers can be hydroentangled as taught in U.S. Pat. No. 4,021,284 issued to Kalwaites on May 3, 1977 and U.S. Pat. No. 4,024,612 issued to Contrator et al. on May 24, 1977, both of which are hereby incorporated herein by reference. In the currently preferred embodiment, the polymeric fibers of the nonwoven are consolidated by point bonds, sometimes referred to as “partial consolidation” because of the plurality of discrete, spaced-apart bond sites.

As used herein, the term “polymer” generally includes, but is not limited to, homopolymers, copolymers, such as, for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic and random symmetries.

As used herein, the term “extensible” refers to any material which, upon application of a biasing force, is elongatable, to at least about 50 percent without experiencing catastrophic failure.

As used herein are all percentages are weight percentages unless otherwise specified.

An abrasion resistant, soft nonwoven of the present invention is produced by the method described with reference to the Figures. The description of the method will also serve to describe the nonwoven web so produced. Although the nonwoven web of the present invention can find beneficial use as a component of a disposable absorbent article, such as a diaper, its use is not limited to disposable absorbent articles. The nonwoven web of the present invention can be used in any application requiring, or benefiting from, softness and abrasion resistance, such as wipes, polishing cloths, furniture linings, durable garments, and the like.

The abrasion resisitant, soft nonwoven of the present invention may be in the form of a laminate. Laminates may be combined by any number of bonding methods known to those skilled in the art including, but not limited to, thermal bonding, adhesive bonding including, but not limited to spray adhesives, hot melt adhesives, latex based adhesives and the like, sonic and ultrasonic bonding, and extrusion laminating whereby a polymer is cast directly onto another nonwoven, and while still in a partially molten state, bonds to one side of the nonwoven, or by depositing melt blown fiber nonwoven directly onto a nonwoven. These and other suitable methods for making laminates are described in U.S. Pat. No. 6,013,151, Wu et al., issued Jan. 11, 2000, and U.S. Pat. No. 5,932,497, Morman et al., issued Aug. 3, 1999, both of which are incorporated by reference herein.

In general, the method of the present invention can be described as a two step process: (1) formation of a consolidated nonwoven having a relatively high consolidation area; and (2) mechanical post-treatment of the relatively highly consolidated nonwoven web. The relatively high consolidation area achieved in the first step results in expected increases in abrasion resistance, but also produces expected relatively high stiffness (i.e., bending rigidity). The bending rigidity correlates to softness, such that an increase in bending rigidity correlates to a decrease in softness.

It has been surprisingly discovered that the bending rigidity intrinsic to the relatively highly consolidated nonwoven web can be significantly reduced, without a corresponding decrease in abrasion resistance, by the mechanical post-treatment methods of the present invention. That is, by the method of the present invention, a highly consolidated web exhibits high levels of abrasion resistance, demonstrated by low fuzzing, as well as high levels of softness, demonstrated by low bending rigidity.

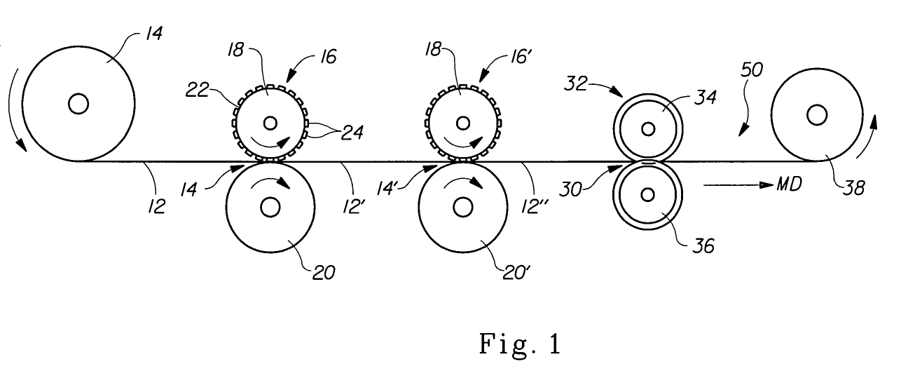

A schematic representation of an apparatus 10 for producing a web 50 of the present invention is shown in FIG. 1. A base nonwoven web 12 is supplied from a roll 14 in the direction shown by the arrows, which direction is denoted as the machine direction MD. Base nonwoven web 12 can be any of nonwoven webs produced by known processes, such as by carding, meltblowing, spunbonding, or air laying, which have sufficient integrity, strength, and extensibility properties to be processed by the methods described herein. In general spunbond nonwoven webs and carded webs comprising suitable elongatable fibers have been successfully processed by the method of the present invention.

Examples of suitable thermoplastic fibers for use in the present invention include, but are not limited to polyethylene, polypropylene, polyethylene-polypropylene copolymers, polyvinyl alcohol, polyesters, nylon, polylactides, polyhydroxyalkanoates, aliphatic ester polycondensates, and mixtures thereof. Bicomponent fibers (e.g. polypropylene/polyethylene) have been found to be particularly suitable for making the nonwovens of the present invention. The bicomponent fibers can be in various configurations such as, but not limited to, sheath/core, side-by-side, segmented pie, hollow segmented pie, islands-in-the-sea, segmented ribbon, and tipped multilobal, with sheath/core being preferred. Natural fibers such as cellulosic (e.g., wood pulp fibers, cotton fibers, hemp fibers, jute fibers, flax fibers, and mixtures thereof), silk fibers, keratin, and starch can also be used in the present invention. These and other suitable fibers and the nonwoven materials prepared therefrom are generally described in Riedel, “Nonwoven Bonding Methods and Materials,” Nonwoven World (1987); and The Encyclopedia Americana, vol. 11, pp. 147-153, and vol. 26, pp. 566-581 (1984) which are all incorporated by reference herein in their entirety.

Base nonwoven web 12 may be produced directly in line with the method of the present invention, thereby not requiring it to be first rolled into roll 14. However, it is currently preferred to provide base nonwoven web 12 on a roll, for further processing as described herein.

Suitable base nonwoven webs 12 can have a basis weight (weight per unit area) from about 10 grams per square meter (gsm) to about to about 100 gsm. The basis weight can also be from about 20 gsm to about 40 gsm, and in one embodiment it was 30 gsm. Suitable base nonwoven webs 12 can have an average filament denier of about 0.10 to about 10. Very low deniers can be achieved by the use of splittable fiber technology, for example. In general, reducing the filament denier tends to produce softer fibrous webs, and low denier microfibers from about 0.10 to 2.0 denier can be utilized for even greater softness.

For commercial feasibility, prior to being processed by the method of the present invention, base nonwoven web 12 should be initially consolidated such that it has sufficient integrity to be handled as roll stock. The degree of consolidation can be expressed as a percentage of the total surface area of the web that is consolidated. Initial consolidation can be substantially complete, as when an adhesive is uniformly coated on the surface of the nonwoven, or when bicomponent fibers are sufficiently heated so as to bond virtually every fiber to every adjacent fiber. Air-through bonding methods can be utilized, as known in the art, for such consolidation. Generally, however, consolidation is preferably partial, as in point bonding, such as thermal point bonding.

The discrete, spaced-apart bond sites formed by point bonding, such as thermal point bonding, only bond the fibers of the nonwoven in the area of localized energy input. Fibers or portions of fibers remote from the localized energy input remain substantially unbonded to adjacent fibers. Similarly, with respect to ultrasonic or hydroentanglement methods, discrete, spaced apart bond sites can be formed to make a partially consolidated nonwoven web. The consolidation area, when consolidated by these methods, refers to the area per unit area occupied by the localized sites formed by bonding the fibers into point bonds (alternately referred to as “bond sites”), typically as a percentage of total unit area. A method of determining consolidation area is detailed below.

Consolidation area can be determined from scanning electron microscope (SEM) images with the aid of image analysis software. For all consolidation areas reported herein, at least three SEM images were taken from different positions on a nonwoven web sample at 20× magnification. These images were saved digitally and imported into Image-Pro Plus® software for analysis. The bonded areas were then traced and the percent area for these areas was calculated based on the total area of the SEM image. The average of three images was taken as the consolidation area for the sample.

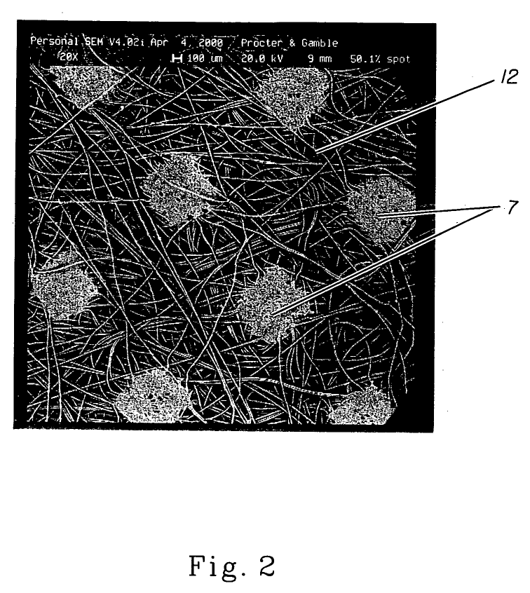

A typical pattern for consolidating via thermally point bonding a fibrous nonwoven with a plurality of discrete bond sites is shown greatly magnified in FIG. 2. The pattern shown in FIG. 2 can be made by the method described in the aforementioned U.S. Pat. No. 3,855,046, for example. The size, number and spacing of discrete bond sites 7 per unit area determine the percent consolidation area. The number, size, shape and pattern of discrete bond sites 7 can be varied, and is dependent on the corresponding size, shape, and pattern of the plurality of raised points on the heated pressure roll(s) used to form the thermal bonds.

A typical consolidated nonwoven web 12 as purchased from a nonwoven supplier, and shown in FIG. 2, has a 14% consolidation area, with a pattern of regularly spaced diamond shaped bond sites generally as shown in FIG. 2. Each diamond-shaped bond site 7 can have a long dimension of about 0.9 mm and a short dimension of about 0.8 mm. The horizontal distance (as viewed in FIG. 2) between horizontally-aligned bond sites can be about 1.5 mm. The vertical distance (as viewed in FIG. 2) between vertically-aligned bond sites can be about 1.5 mm. The distance between vertically-columnar rows or horizontally-oriented rows (as viewed in FIG. 2) of bond sites can be 0.30 to 0.35 mm. Consolidated nonwoven webs are not typically produced with higher percentage consolidation areas because greater consolidation produces an unacceptably stiff nonwoven web.

A web of the present invention preferably exhibits a percent consolidation area of between about 22% and about 50% prior to mechanical post-treatment. Without being bound by theory, it is believed that higher consolidation areas, up to 60% or 70%, can be utilized with similarly-beneficial results. Therefore, typical consolidated nonwoven webs as purchased from nonwoven vendors must be further consolidated by additional consolidation, e.g., point bonding, to achieve the levels of abrasion resistance desired for some components of disposable absorbent articles, such as backsheets for diapers. This additional consolidation via additional point bonding, termed “overbonding” herein, is effective at increasing the abrasion resistance of the web because the higher the consolidation area, the more fibers are constrained by bonding to adjacent fibers, and therefore, fuzzing is decreased and abrasion resistance is increased. Therefore, in general, the higher the consolidation area, the less fuzzing is experienced for a given fibrous nonwoven web. However, as discussed above, a higher consolidation area typically produces a stiffer web, and therefore, a less soft web. Bending rigidity correlates with softness, such that an increase in bending rigidity corresponds to an increase in softness, that is, perceived softness when handled by a user or felt by a wearer.

Applicants have unexpectedly discovered, however, that further processing of a web having a relatively high consolidation area, including “overbonded” webs, by mechanical post-treatment, as disclosed below, can result in a nonwoven web having relatively high abrasion resistance and relatively low bending rigidity. In fact, the bending rigidity of a web of the present invention can be less than the bending rigidity of the base nonwoven, without a decrease in abrasion resistance. That is, by the method of the present invention, a web of the present invention can be made that is softer than the base nonwoven web, without an increase in fuzzing levels. In certain embodiments, both the softness and the abrasion resistance of the base nonwoven are significantly improved.

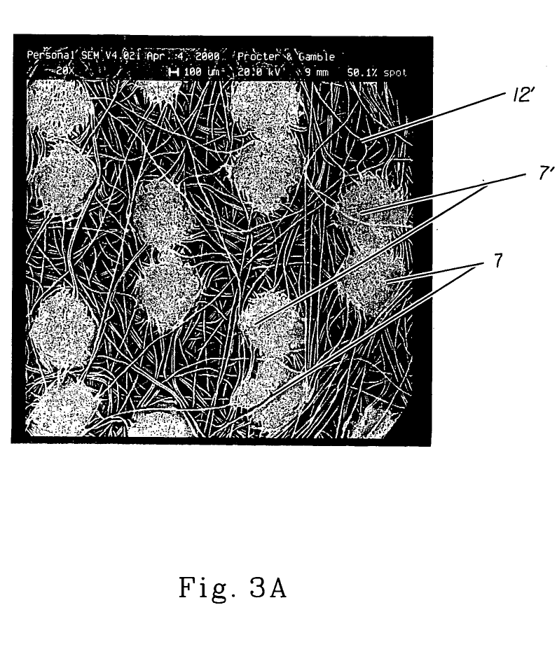

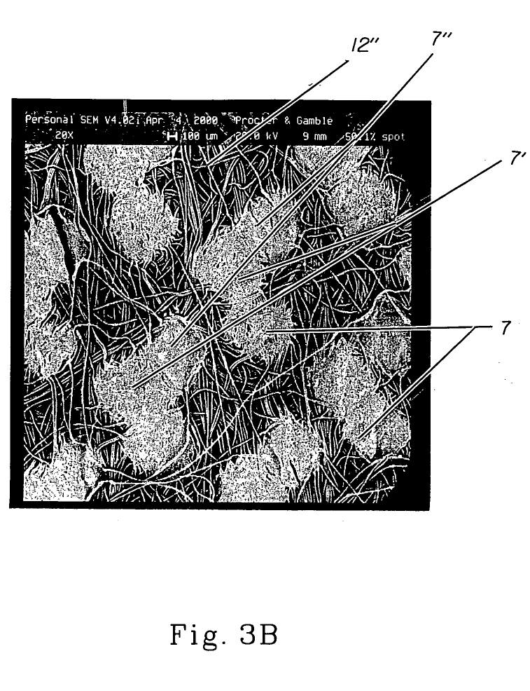

If base nonwoven web 12 does not already have a sufficiently high consolidation area, it must be processed to increase the consolidation area. Currently, no commercially-available nonwoven webs having sufficient consolidation area for purposes of the present invention have been identified. Therefore, additional consolidation is required to provide for sufficient total consolidation area. As shown in FIG. 1, a preferred method for additional consolidation (i.e., overbonding), is by the use of a thermal point bond roller arrangement 16, which can be a bonding operation as described in the aforementioned U.S. Pat. No. 3,855,046, or other similar and improved operations as are known in the art. Base nonwoven 12 is fed into the nip 14 of thermal point bond roller arrangement 16, which comprises a patterned calendar roller 18 and a smooth anvil roller 20. One or both of the patterned calendar roller 18 and the smooth anvil roller 20 are heated and the pressure between the two rollers is adjusted by well known means to provide the desired temperature and pressure to form additional bond sites 7′, as shown in FIG. 3A. As shown in FIG. 3A, additional bond sites 7′ may or may not overlap the existing bond sites 7 in base nonwoven web 12, but after processing through the thermal bond roller arrangement 16 the consolidation area of overbonded web 12′ is typically greater than that of the base nonwoven web 12. If an identical bond pattern is used for the overbonding as was used for the base nonwoven, as shown in FIG. 3A, the consolidation area of overbonded web 12′ can be up to 100% greater than that of the base nonwoven web 12

Typically, additional bond sites 7′ of overbonded web 12′ will not lie totally in registry with existing bond sites 7 of base nonwoven 12, even if the same bond pattern is used for overbonded web 12′. In fact, base nonwoven 12 need not have any existing bond sites, but may be partially consolidated by other means, for example, by adhesive bonding. In a preferred embodiment, however, base nonwoven web 12 is a thermally point bonded web having a relatively low consolidation area. In general, due to inherent misalignment, or differences in patterns of patterned roller 18, additional bond sites 7′ typically significantly increase the consolidation area of the base nonwoven web 12 being processed.

If additional consolidation is necessary to increase the consolidation area, overbonded nonwoven web 12′ can be further processed by additional passes through the same (after being rolled as roll stock and re-entered into nip 13 by known methods), or another thermal bond roller arrangement, such as secondary thermal bond roller arrangement 16′ to produce nonwoven web 12″ having further additional overbonded bond sites. Secondary thermal bond roller arrangement 16′ operates in an analogous manner as thermal bond roller arrangement 16, and the components designated as “prime” numbers are analogous to the corresponding components of thermal bond roller arrangement 16. As shown in FIG. 3B, secondary thermal bond roller arrangement 16′ produces additional overbonding, forming additional bond sites 7″ which further increase the consolidation area of web 12″. As before, additional bond sites 7″ may or may not overlap the existing bond sites 7 in base nonwoven web 12, or bond sites 7′ in overbonded web 12′, but if the same bond patterns are used, as shown in FIG. 3B, after processing through the thermal bond roller arrangement 16′ the consolidation area of overbonded web 12″ can be 200%-300% greater than that of the base nonwoven web 12.

The nonwoven web being processed can be overbonded through a thermal bond roller arrangement 16 or 16′, etc., as many times as necessary to achieve sufficiently high consolidation area in the web prior to stretching as described below. Alternatively, it is believed that a single thermal bond roller arrangement 16 having sufficient numbers and spacing of point bonding protuberances can be utilized, thus achieving adequate consolidation area in a single point bonding operation. In general, it has been found that a consolidation area of greater than 20%, preferably at least 25%, and more preferably at least 30% prior to stretching is sufficiently high for purposes of the present invention. Consolidation areas as great as 40% prior to stretching have also been successfully utilized in webs of the present invention, and consolidation areas greater than 50% to 60% are believed be feasible.

The patterned calendar roller 18 (and 18′, etc.) is configured to have a circular cylindrical surface 22, and a plurality of protuberances or pattern elements 24 which extend outwardly from surface 22. The protuberances 24 are disposed in a predetermined pattern. The pattern of protuberances on patterned calendar roller 18 may produce a pattern of bond sites identical to that of the original base nonwoven web 12 (as manufactured or as supplied from the vendor), or it may produce a pattern much different, either in the size, shape, or spacing of the bond sites 7. Protuberances can extend outwardly from surface 22 a distance of from about 0.01 inch to about 0.10 inch and can be positioned in a density of about 50 to 300 protuberances/square inch. In a preferred embodiment, the protuberances are distributed in a predetermined pattern in a density of about 144/square inch.

The temperature of patterned calendar roller 18 should be sufficiently high to cause effective melt bonding of adjacent fibers throughout the nonwoven web in the localized melt bond site. By “throughout” is meant through the thickness of the nonwoven web in the localized melt bond area. “Effective” melt bonding is achieved when most of the fibers in the localized melt zone of a particular bond site are captured and thermally bonded into a visually distinct bond site. Effective bonding is dependent upon factors that can be variably altered by known methods, such as bond pattern, surface area of protuberances, thickness, basis weight, and composition of the nonwoven web, and line speed. In general, polyolefinic spunbond webs can be overbonded with roller 18 temperatures from about 180° F. to about 325° F. For the polyolefinic bicomponent fibers in a nonwoven web having a basis weight of 30 gsm, as shown in the Examples below, calendar roll temperatures of about 240-250° F. were used. Other suitable processing parameters such as nip pressures and line speeds can be determined by one skilled in the art, depending on the basis weight and material composition of base web 12.

Virtually any of known patterns and methods of thermal calendar point bonding can be used to impart additional consolidation area to the base nonwoven web 12. Without being bound by theory, it is believed that sufficient consolidation area can be achieved in one thermal point bonding process. However, it has been found that there is benefit in achieving the desired consolidation area in multiple passes as described above. As shown in the Examples below, by forming sufficient consolidation area in multiple passes, the temperature of patterned calendar roller 18 can be varied with each pass, thereby imparting beneficial temperature-dependent properties to the final web. For example, it has been found beneficial to process a base nonwoven web 12 through thermal bond roller arrangement 16, 16′, etc., at least twice to produce the web 100 of the present invention, with the second bonding achieved at a lower temperature than the first.

Patterned calendar roller 16 can have a repeating pattern of protuberances 24 which extend about the entire circumference of surface 22. Alternatively, the protuberances 24 may extend around a portion, or portions of the circumference of surface 22. Likewise, the protuberances 24 may be in a non-repeating pattern.

Anvil roller 20 is preferably a smooth surfaced, right circular cylinder of steel. The pressure between patterned calendar roller 16 and anvil roller 20 can be varied by methods known in the art to produce sufficient pressure to adequately form bond sites 50. After overbonded web 12′, 12″, etc., has been sufficiently consolidated, that is, the consolidation area is sufficiently high, the web 12′, 12″, etc., is next uniformly stretched to effectively lower the basis weight in the unbonded regions of the web. Stretching can be accomplished by known methods, but it is believed that uniform stretching is best achieved by utilizing an incremental stretching system, as described herein. In addition to lowering the basis weight, the incremental stretching system of the present invention simultaneously softens the web, gives it better hand and lowers its bending rigidity.

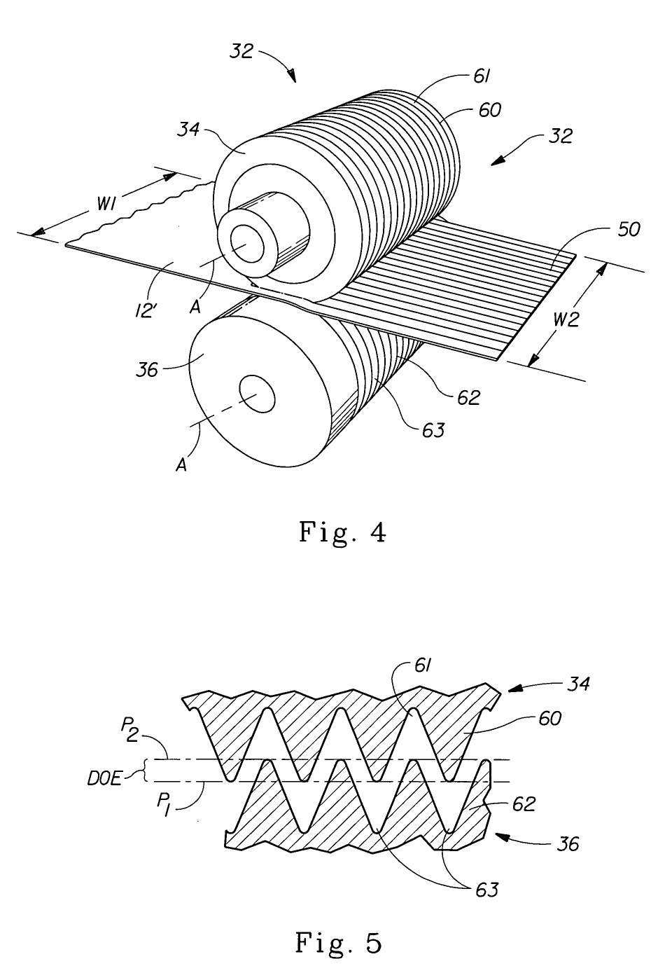

Stretching of the overbonded web is preferably achieved by incremental stretching. Overbonded web (12′, 12″, etc.) is fed into the nip 30 formed by an incremental stretching system 32 employing opposed pressure applicators 34 and 36 having three-dimensional surfaces which at least to a degree are complementary to one another. Referring now to FIG. 4, there is shown an incremental stretching system 32, commonly referred to as a “ring rolling” system, comprising incremental stretching rollers 34 and 36, each of which rotate about their respective axes A in an inter-engaged relationship. Incremental stretching roller 34 includes a plurality of teeth 60 and corresponding grooves 61 which extend about the entire circumference of roller 34. Incremental stretching roller 36 includes a plurality of teeth 62 and a plurality of corresponding grooves 63 which extend about the entire circumference of roller 36. The teeth 60 on roller 34 intermesh with or engage the grooves 63 on roller 36, while the teeth 62 on roller 36 intermesh with or engage the grooves 61 on roller 34. The teeth of each roller are generally triangular-shaped, as shown in FIG. 5, but can be significantly elongated to increase the depth of engagement between the mating rollers. The apex of the teeth are slightly rounded with a predetermined radius of curvature, which can be varied as desired, or as required for certain effects in the finished web.

FIG. 5 shows in cross-section a fragmentary view of a portion of incremental stretching rollers 34 and 36. The term “pitch” as used herein, refers to the distance between the apexes of adjacent teeth on a given roller, 34 or 36. The pitch can be between about 0.02 to about 0.30 inches, and is preferably between about 0.05 and about 0.15 inches. The height (or depth) of the teeth is measured from the base of the tooth to the apex of the tooth, and is preferably equal for all teeth. The height of the teeth can be between about 0.10 inches and 0.90 inches, and is preferably about 0.25 inches and 0.50 inches.

The teeth 60 in one roll are typically offset by one-half the pitch from the teeth 62 in the other roll, such that the teeth of one roll (e.g., teeth 60) mesh in the valley (e.g., valley 63) between teeth in the mating roll. The offset permits intermeshing of the two rollers when the rollers are “inter-engaged” or in an intermeshing, operative position relative to one another. In a preferred embodiment, the teeth of the respective rollers are only partially intermeshing, or may be offset by more or less than one-half the pitch.

The degree to which the teeth on the opposing rolls intermesh is referred to herein as the “depth of engagement” (alternately referred to as “DOE” herein) of the teeth. As shown in FIG. 5, the DOE is the distance between a position designated by plane P1 where the apexes of the teeth on the respective rolls are in the same plane (0 inches engagement) to a position designated by plane P2 where the apexes of the teeth of one roll extend inward beyond the plane P1 toward the valley on the opposing roll. The optimum or effective DOE for particular nonwoven webs is dependent upon the height and the pitch of the teeth and the materials of the web, all of which can be varied as desired.

In other embodiments the teeth of the mating rolls need not be aligned with the valleys of the opposing rolls. That is, the teeth may be out of phase with the valleys to some degree, ranging from slightly offset to greatly offset.

As the nonwoven web 12′, 12″, etc., passes through the incremental stretching system 32 it is subjected to tensioning in the CD, or cross-machine direction, (which is orthogonal to the machine direction MD generally in the plane of the MD) causing it to be extended in the CD direction. Alternatively, or additionally, the nonwoven web 12′, 12″, etc., may be tensioned in the MD (machine direction) as described below. After being subjected to the tensioning force applied by the incremental stretching system 32, the overbonded, stretched, nonwoven web is an abrasion resistant, soft nonwoven web, denoted 50 in FIG. 1, which exhibits dramatically improved softness as demonstrated by relatively low bending rigidity characteristics.

### Examples, Supporting Data, and Analysis

The Tables below summarize the results of several embodiments (Samples) of web 50 of the present invention. The data reported in the Tables below is shown for various Samples, identified by Sample Numbers for consistency in each of the Tables below. For all the Samples tested and reported in the Tables below, base nonwoven 12 was a 30 gsm spunbond 80/20 sheath/core PE/PP partially consolidated nonwoven obtained from BBA Nonwovens (Simpsonville, S.C.) having a bond pattern of a plurality of discrete, spaced apart diamond shape bond sites 7 in a pattern density of 144 pins/in² and 14% consolidation area (similar to that shown in FIG. 2). The base nonwoven 12 was overbonded one or two times using a thermal bond roller arrangement 16 as described above. The first or second overbonding passes were either at the same temperature as the original bonding of the base nonwoven web 12 (250° F.) or at a lower temperature (240° F.).

Each Sample (except Sample 1, which is the base nonwoven) was processed by overbonding and stretching in the CD direction by incremental stretching as described above with respect to incremental stretching system 32 (as shown in FIGS. 1 and 4). The incrementally stretched Samples are noted in the Tables by the notation “(IS)”. Incremental stretching was achieved using mating rollers having a 0.060″ pitch at a speed of 500 ft/min. The depth of activation (DOE) for the incrementally stretched Samples was varied as shown in the Tables to determine the effects on fuzz levels and bending rigidity for each material.

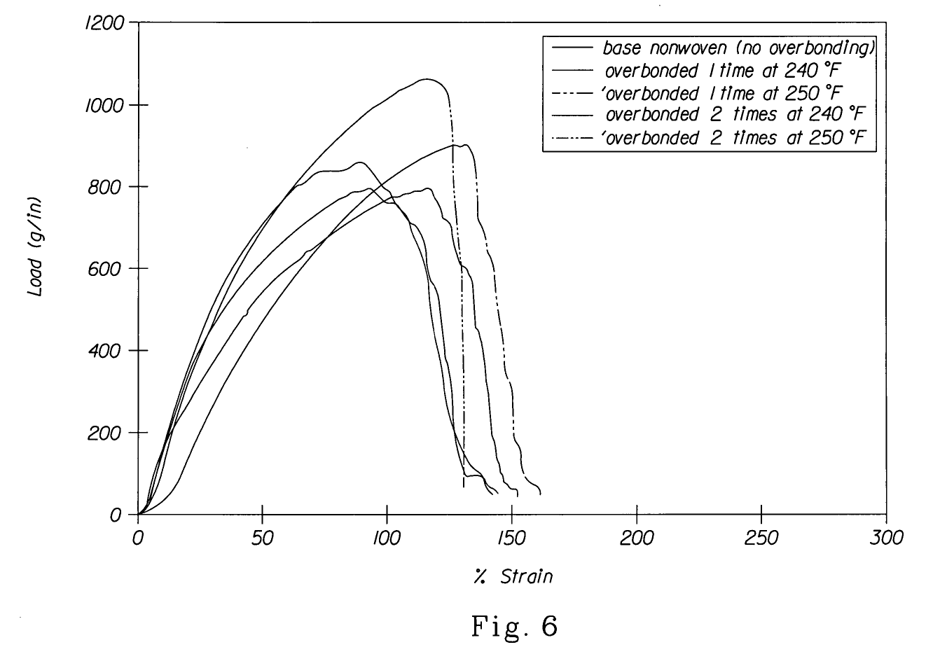

One surprising discovery that contributes to the successful manufacture of the web of the present invention is that overbonding of a nonwoven web by the method described above does not significantly decrease the tensile elongation at break characteristic of the base nonwoven web 12. For example, elongation at break in the cross-machine (CD) direction data is shown in Table 1, portions of which are graphed in FIG. 6 (for the base nonwoven overbonded but not incrementally stretched). The CD Peak Load and CD Break Elongation data points of Table 1 were obtained by standard tensile test method below.

As shown in Table 1 and the graph in FIG. 6, overbonding once or twice at various temperatures did not significantly change the elongation at break properties of the base nonwoven web. This is surprising, since in previous development work, attempts at achieving maximum elongation to break properties were guided by nonwoven suppliers' recommendations to select nonwoven materials having relatively low consolidation area (e.g., 14% or less). The elongation to break characteristics exhibited by the overbonded nonwoven webs are important to successful processing by stretching as described above.

TABLE 1
Cross-Direction Tensile Properties for Webs of the Present Invention

| | | | CD | |
|---|---|---|---|---|
| | | | Tensile | CD Break |
| Sample | | DOE | at Peak | Elongation |
| # | Description | (in) | (g/in) | (%) |
| 1 | Base nonwoven (Base) | * | 791 | 143 |
| 1-A | Base-(IS) | 0.060 | 573 | 147 |
| 1-B | Base-(IS) | 0.075 | 359 | 219 |
| 1-C | Base-(IS) | 0.095 | 158 | 277 |
| 2 | Overbonded once at 250° F. | * | 967 | 154 |
| 2-A | Overbonded once at 250° F. - (IS) | 0.060 | 667 | 135 |
| 2-B | Overbonded once at 250° F. - (IS) | 0.075 | 380 | 179 |
| 3 | Overbonded 1 time at 240° F. | * | 805 | 130 |
| 3-A | Overbonded once at 240° F. - (IS) | 0.060 | 454 | 164 |
| 3-B | Overbonded once at 240° F. - (IS) | 0.075 | 211 | 206 |
| 3-C | Overbonded once at 240° F. - (IS) | 0.095 | 140 | 254 |
| 4 | Overbonded twice at 250° F. | * | 1111 | 124 |
| 4-A | Overbonded twice at 250° F. - (IS) | 0.060 | 493 | 133 |
| 4-B | Overbonded twice at 250° F. - (IS) | 0.075 | 304 | 165 |
| 5 | Overbonded twice at 240° F. | * | 860 | 134 |
| 5-A | Overbonded twice at 240° F. - (IS) | 0.060 | 481 | 165 |
| 5-B | Overbonded twice at 240° F. - (IS) | 0.075 | 184 | 228 |
| 5-C | Overbonded twice at 240° F. - (IS) | 0.095 | 90 | 257 |

After being subjected to the tensioning force applied by the incremental stretching system 32, the web 50 can have a variable width, depending on the pitch, DOE, and the extent to which the undulations formed by the incremental stretching system 32 are flattened out, such as by spreading, or extension in a direction generally parallel to the direction of incremental stretching. For example, as the nonwoven web exits incremental stretching system 32, it can be spread out, or extended in the cross-machine (CD) direction to have a width, W2, greater than the width, W1, prior to incremental stretching. As discussed, the amount of spread is dependent upon the incremental stretching system 32 parameters, such as the pitch and depth of engagement of the inter-engaging teeth, as well as the tension applied in rewinding onto roll 38. In general, however, a slight spreading of the web upon exiting incremental stretching system 32 can be expected prior to being wound on roll 32, and is not considered detrimental. The amount of spreading can be controlled by the winding tension when winding the web 50 into roll stock, and the actual width of web 50 can be controlled to approximate the width of overbonded web 12′ or 12″, etc. That is, the overall width W2 of web 50 (as shown in FIG. 4) can be kept the same as the width W1 of overbonded web 12′ or 12″, etc. prior to stretching by keeping the undulations produced by incremental stretching system 32 substantially intact. By increasing the tension of the rewind roll 38 as shown on FIG. 1, the width W2 can also be less than width W1 due to necking of the material.

One factor influenced by the tendency of the web 50 to spread or extend in the CD after exiting incremental stretching system 32 is the resulting consolidation area of web 50. Because the amount of extension available is variable, depending on the parameters of incremental stretching system 32, the final consolidation area is also variable. As shown in Table 2, the consolidation area of web 50 can be measured in an “as wound” condition in which there is little or no actual increase in web width (i.e., W1 approximately equal to W2). In the “as wound” condition, the consolidation area of web 50 is observed to be about 20% to about 30%. In general, as shown by the Samples in Table 2, the consolidation area as a percentage can be expected to be less after incremental stretching, accounting for an increase in surface area prior to winding on roll 38. For example, in the Sample 4 series, the consolidation area decreased from 30% to 21% for a 27% decrease. In the Sample 5 series, the consolidation area decreased from 37% to 21% for a 43% decrease. Likewise, for the same Samples when spread or flattened, the consolidation area is typically reduced to about 12%-15% (e.g., Sample 5-B). Table 2 below summarizes consolidation area measurements for each of the Samples.

TABLE 2
Consolidation Area of Webs of the Present Invention

| | | | | | | Bonded | Unbonded | |
|---|---|---|---|---|---|---|---|---|
| | | | | | Basis | Area | Area | Basis |
| | | | % Bond | % Bond | Weight | Basis | Basis | Weight |
| | | DOE | Area (as | Area | (spread) | Weight | Weight | Differential |
| Sample # | Description | (in) | wound) | (spread) | (g/m²) | (g/m²) | (g/m²) | (g/m²) |
| 1 | Base nonwoven | * | 14 | 14 | 30 | 30 | 30 | 0 |
| | (Base) | | | | | | | |
| 1-A | Base-(IS) | 0.060 | 14 | 13 | 26 | 30 | 25 | 15 |
| 1-B | Base-(IS) | 0.075 | 13 | 10 | 22 | 30 | 21 | 30 |
| 1-C | Base-(IS) | 0.095 | 13 | 10 | 19 | 30 | 18 | 41 |
| 2 | Overbonded | * | 29 | 29 | 35 | 35 | 35 | 0 |
| | once at 250° F. | | | | | | | |
| 2-A | Overbonded | 0.060 | 22 | 19 | 26 | 35 | 24 | 32 |
| | once at 250° F. - | | | | | | | |
| | (IS) | | | | | | | |
| 2-B | Overbonded | 0.075 | 23 | 17 | 27 | 35 | 25 | 28 |
| | once at 250° F. - | | | | | | | |
| | (IS) | | | | | | | |
| 3 | Overbonded 1 | * | 30 | 30 | 28 | 28 | 28 | 0 |
| | time at 240° F. | | | | | | | |
| 3-A | Overbonded | 0.060 | 21 | 15 | 23 | 28 | 22 | 21 |
| | once at 240° F. - | | | | | | | |
| | (IS) | | | | | | | |
| 3-B | Overbonded | 0.075 | 21 | 12 | 17 | 28 | 16 | 45 |
| | once at 240° F. - | | | | | | | |
| | (IS) | | | | | | | |
| 3-C | Overbonded | 0.095 | 21 | 12 | 17 | 28 | 16 | 45 |
| | once at 240° F. - | | | | | | | |
| | (IS) | | | | | | | |
| 4 | Overbonded | * | 40 | 40 | 34 | 34 | 34 | 0 |
| | twice at 250° F. | | | | | | | |
| 4-A | Overbonded | 0.060 | 29 | 26 | 26 | 34 | 23 | 32 |
| | twice at 250° F. - | | | | | | | |
| | (IS) | | | | | | | |
| 4-B | Overbonded | 0.075 | 30 | 21 | 26 | 34 | 24 | 30 |
| | twice at 250° F. - | | | | | | | |
| | (IS) | | | | | | | |
| 5 | Overbonded | * | 37 | 37 | 29 | 29 | 29 | 0 |
| | twice at 240° F. | | | | | | | |
| 5-A | Overbonded | 0.060 | 21 | 14 | 19 | 29 | 17 | 40 |
| | twice at 240° F. - | | | | | | | |
| | (IS) | | | | | | | |
| 5-B | Overbonded | 0.075 | 23 | 12 | 18 | 29 | 17 | 43 |
| | twice at 240° F. - | | | | | | | |
| | (IS) | | | | | | | |
| 5-C | Overbonded | 0.095 | 21 | 12 | 17 | 29 | 15 | 47 |
| | twice at 240° F. - | | | | | | | |
| | (IS) | | | | | | | |

The decrease in consolidation area is a result of the overall increase in web area due to the incremental stretching. The overall increase in web area also has the effect of lowering the overall web basis weight, as indicated in Table 2 above. Because basis weight is a measure of weight per unit area, the overall basis weight of the web 50 of the present invention depends upon the amount of spread in the web after incremental stretching. The basis weights of the finished webs 50 shown for each Sample in Table 2 above are average basis weights for each web when fully spread or extended. However, in general, it can be stated that the basis weight in the unbonded regions of web 50 are significantly less than the basis weight of the bond sites 7, 7′, 7″, etc. This is because the basis weight of the bonded regions, i.e., bond sites 7, 7′, 7″, etc., is essentially the same as the basis weight of base nonwoven web 12 prior to processing by the method of the present invention. Therefore, for each of the finished webs 50 reported in the Table 2 above, the basis weight of the bond sites remains essentially 30 gsm. The term “essentially” is used because of slight very localized differences in basis weight of the nonwoven web, as well as some contraction of fibers as described below, which may result in a slight variation in the actual basis weight at the bond sites. However, in general, the average basis weight at the bond sites can be considered to be essentially the same as the average basis weight of the base nonwoven web 12.

Some contraction of the fibers can occur upon heating to form bond sites which can increase the overall basis weight of overbonded web 12, 12′, etc., prior to incremental stretching. For example, as shown in Table 2 above, Samples 2 and 4, which were overbonded at 250° F. show a slight increase in web basis weight prior to incremental stretching. Samples 3 and 5, each bonded at 240° F. show negligible change in the basis weight of base nonwoven (Sample 1). However, in each Sample the unbonded regions undergo significant stretching, which decreases the basis weight of these regions. For example, in the Sample 2 series, there is a decrease in the basis weight of the overall web between Sample 2 and Sample 2-B of almost 23%. Likewise, in the Sample 5 series, there is a decrease in overall web basis weight of greater than 40% between Sample 5 and Sample 5-C.

Because the bond sites are very localized, discrete, and have essentially the same basis weight as the base nonwoven web, the basis weight of the unbonded regions (and therefore a basis weight differential) can be calculated. The following equation was used to calculate the basis weight of the unbonded regions (BW_{U}), assuming that the basis weight of the bonded regions (BW_{B}) is essentially the same as the basis weight of the base nonwoven web (BWᵢ):

$$BA * {BW}_{B} + ( 1 - BA ) * {BW}_{U} = {BW}_{T}$$

$${BW}_{U} = \frac{{BW}_{T} - BA * {BW}_{i}}{( 1 - BA )}$$

where BA is the fractional bond area of the web and BW_{T} is the total measured basis weight of the web. These values are calculated for each of the samples and shown in Table 2. Thus, a basis weight differential from about 15% to about 47% is observed between the bond sites and the surrounding, unbonded areas of finished web 50. In general, therefore, it is observed that the overall average basis weight of the web 50 is significantly lower than base nonwoven web 12, or overbonded webs 12′, or 12″, as reflected in the data of Table 2, which indicates that the webs of the present invention exhibit a basis weight differential throughout the web.

Accordingly, the web 50 can be characterized as a relatively planar nonwoven web comprising only the fibers of a nonwoven web (i.e., the base nonwoven web, with no additional components such as adhesives, particulate matter, and the like) having a plurality of discrete, spaced apart (either regularly, or randomly spaced) regions of relatively high basis weight regions, the relatively high basis weight regions being at least partially surrounded generally in the plane of the web by a relatively low basis weight region. As opposed to the discrete nature of the relatively high basis weight regions, the relatively lower basis weight region can be characterized as “continuous”. That is the relatively low basis weight region can be described as a net-like, or reticulated, pattern, wherein any point on the web in the relatively low basis weight region can be reached from any other point on the web in the relatively low basis weight region, without leaving the surface of the web or necessarily crossing over any regions of relatively high basis weight.

Another benefit of the variable basis weight characteristic of web 50 is its relatively low basis weight (overall, average) but relatively high number of fibers captured by point bonds. That is, substantially all of the fibers bonded during the bonding process described herein remain bonded after incremental stretching. Even though some of the thermal bond sites fracture due to the incremental stretching, it can be shown by magnified observation that almost all of the bonded fibers remain bonded. Thus, the lower basis weight web of the present invention can be achieved without sacrificing the actual number of fibers captured in bond sites. Therefore, the consolidation level, that is, the number of fibers captured and immobilized by consolidation, can remain relatively high, in a relatively low basis weight web. This greatly benefits the abrasion resistance characteristics as determined by fuzz levels reported more fully below.

The web of the present invention is characterized by high abrasion resistance and high softness, which properties are quantified by the webs tendency to fuzz and bending rigidity, respectively. Fuzz levels and bending rigidity were determined by the methods described in the Test Methods section below, and the data is reported in Table 3 below.

TABLE 3
Fuzz Level and Bending Rigidity for Webs of the Present Invention

| | | | | MD Fuzz | MD |
|---|---|---|---|---|---|
| | | | | (Pattern | Bending |
| | | DOE | % Consolidation | Side) | Rigidity |
| Sample # | Description | (in) | Area | (mg/cm²) | (g * cm²/cm) |
| 1 | Base nonwoven (Base) | * | 14 | 0.32 | 0.018 |
| 1-A | Base-(IS) | 0.060 | 14 | 0.42 | 0.017 |
| 1-B | Base-(IS) | 0.075 | 13 | 0.46 | 0.015 |
| 1-C | Base-(IS) | 0.095 | 13 | 0.50 | 0.012 |
| 2 | Overbonded once at 250° F. | * | 29 | 0.25 | 0.029 |
| 2-A | Overbonded once at 250° F. - (IS) | 0.060 | 22 | 0.30 | 0.019 |
| 2-B | Overbonded once at 250° F. - (IS) | 0.075 | 23 | 0.30 | 0.017 |
| 3 | Overbonded 1 time at 240° F. | * | 30 | 0.23 | 0.020 |
| 3-A | Overbonded once at 240° F. - (IS) | 0.060 | 21 | 0.28 | 0.013 |
| 3-B | Overbonded once at 240° F. - (IS) | 0.075 | 21 | 0.24 | 0.008 |
| 3-C | Overbonded once at 240° F. - (IS) | 0.095 | 21 | 0.30 | 0.009 |
| 4 | Overbonded twice at 250° F. | * | 40 | 0.19 | 0.026 |
| 4-A | Overbonded twice at 250° F. - (IS) | 0.060 | 29 | 0.28 | 0.018 |
| 4-B | Overbonded twice at 250° F. - (IS) | 0.075 | 30 | 0.34 | 0.016 |
| 5 | Overbonded twice at 240° F. | * | 37 | 0.23 | 0.021 |
| 5-A | Overbonded twice at 240° F. - (IS) | 0.060 | 21 | 0.33 | 0.012 |
| 5-B | Overbonded twice at 240° F. - (IS) | 0.075 | 23 | 0.32 | 0.010 |
| 5-C | Overbonded twice at 240° F. - (IS) | 0.095 | 21 | 0.30 | 0.007 |

By examining the data in Table 3, one can see that compared to the base material, it is possible by the method of the present invention to produce a web 50 of the present invention having better (i.e., decreased) fuzzing properties, and better (i.e., lower) bending rigidity in the Machine Direction (MD) than the base material. (MD bending rigidity is shown, since, for stretching in the CD direction by incremental stretching as described above with respect to incremental stretching system 32 (as shown in FIGS. 1 and 4), it is known in the art that CD bending rigidity is inherently low) Thus, it is possible to improve both properties, solving the technical contradiction that previously existed between achieving relatively high levels of abrasion resistance while simultaneously achieving relatively high levels of softness.

The benefit of overbonding is made apparent by the comparison of the Sample 1 series with the remaining Samples. Sample 1, which was incrementally stretched, but not first overbonded, shows an expected decrease in bending rigidity, but, likewise, shows an expected increase in fuzzing activity. However, when the base nonwoven is first overbonded, as shown in Samples 2-5, the fuzzing levels are reduced, in most cases, to a level below the base nonwoven (i.e., less than 32 gm/cm²). A significant improvement in bending rigidity is exhibited by the Samples that were overbonded at 240° F. followed by incremental stretching. Again, the improvement in bending rigidity correlates to a dramatic improvement in softness, and the softness increase is achieved simultaneously with a decrease in fuzzing levels, which correlates to better abrasion resistance.

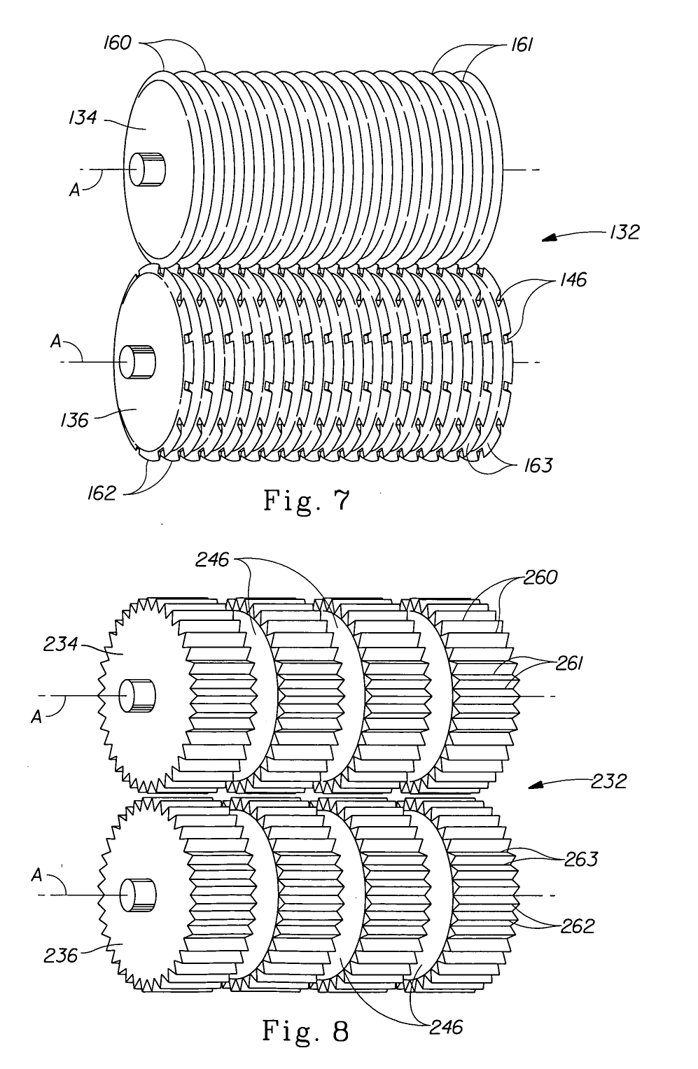

Further beneficial modifications of the method described above are contemplated. For example, instead of two substantially identical rolls 34 and 36, one or both rolls can be modified to produce extension and additional patterning. For example, one or both rolls can be modified to have cut into the teeth several evenly-spaced thin planar channels 146 on the surface of the roll, as shown on roll 136 in FIG. 7. In FIG. 7 there is shown a perspective view of an alternative incremental stretching system 132 comprising incremental stretching rollers 134 and 136 each of which rotate about their respective axes A. Incremental stretching roller 134 includes a plurality of teeth 160 and corresponding grooves 161 which extend about the entire circumference of roller 134. Incremental stretching roller 136 includes a plurality of teeth 162 and a plurality of corresponding grooves 163. The teeth 160 on roller 134 intermesh with or engage the grooves 163 on roller 136, while the teeth 162 on roller 136 intermesh with or engage the grooves 161 on roller 134. The teeth on one or both rollers can have channels 146 formed, such as by machining, such that regions of undeformed nonwoven web material may remain after stretching. Suitable pattern rolls are described in U.S. Pat. No. 5,518,801, issued May 21, 1996, in the name of Chappell, et al., and U.S. Pat. No. 5,650,214 issued to Anderson et al. on Jul. 22, 1997, both of which disclosures are hereby incorporated herein by reference.

Likewise, the incremental stretching can be by mating rolls oriented to stretch nonwoven web 12, or 12′, etc. in the machine direction (MD), as shown in FIG. 8, with or without channels 246. The alternative rolls shown comprise incremental stretching rollers 234 and 236 each of which rotate about their respective axes A. Such rolls comprise a series of ridges 260, 262, and valleys, 261, 263 that run parallel to the axis, A, of the roll, either 234 or 236, respectively. The ridges form a plurality of triangular-shaped teeth on the surface of the roll. Either or both rolls may also optionally have a series of spaced-apart channels 246 that are oriented around the circumference of the cylindrical roll.

In one embodiment, the method of the present invention can comprise both CD and MD incremental stretching. Two (or more) pairs of incremental stretching rolls as described above can be used in line, such that one pair (132, which, as shown in FIG. 7 includes a series of spaced-apart channels 146) performs CD stretching, and another pair, 232 (as shown in FIG. 8) performs MD stretching.

### Disposable Absorbent Article

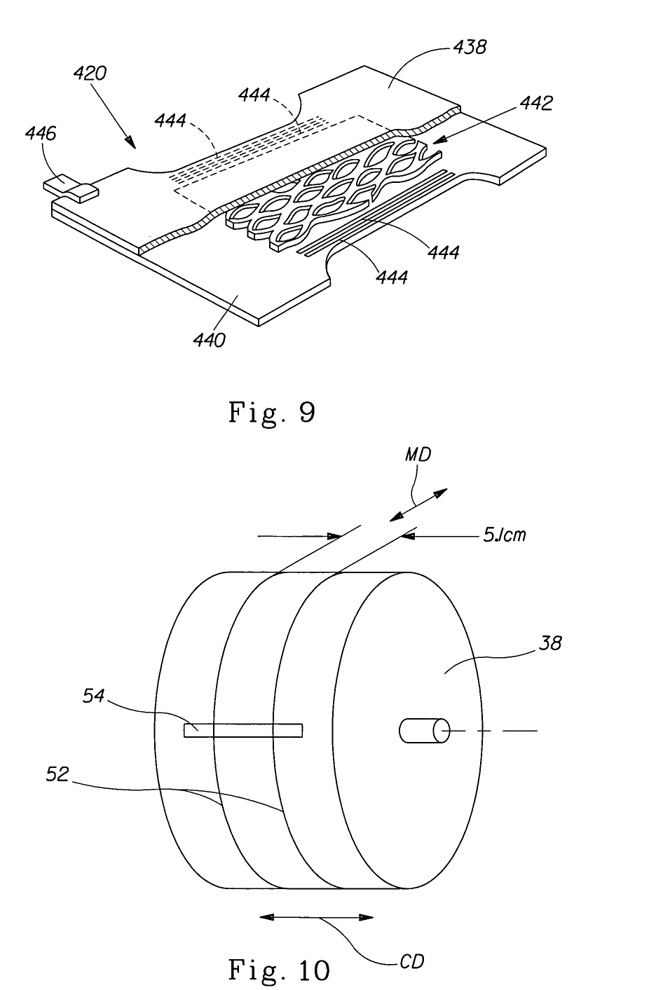

FIG. 9 shows an exemplary embodiment of a disposable diaper 420 in a flat configuration (with all elastic induced contraction removed) with portions of the structure being cut-away to more clearly show the construction. The portion of the diaper which contacts the wearer faces the viewer. The diaper preferably comprises a liquid pervious topsheet 438; a liquid impervious backsheet 440 joined with the topsheet 438; an absorbent core 442 (shown as an apertured laminate of the present invention) positioned between the topsheet 338 and the backsheet 340; elastic members 344; and tape tab (or mechanical) fasteners 446. The components can be assembled in a variety of well known configurations.

Liquid pervious topsheet 438 can comprise a nonwoven web of the present invention. Likewise, backsheet 440 could comprise a nonwoven web of the present invention. Side panels, elastic leg cuffs, and an elastic waist feature can also comprise a nonwoven web of the present invention.

A preferred configuration for a diaper that can comprise a nonwoven web of the present invention in components as described above is described generally in U.S. Pat. No. 3,860,003, issued Jan. 14, 1975 to Buell. Alternatively preferred configurations for disposable diapers are also disclosed in U.S. Pat. No. 4,808,178 (Aziz et al.); U.S. Pat. No. 4,695,278 (Lawson); U.S. Pat. No. 4,816,025 (Foreman); U.S. Pat. No. 5,151,092 (Buell et al.), all of which are hereby incorporated herein by reference.

In addition to disposable diapers, various embodiments of nonwoven webs 50 of the present invention are useful for topsheets, backsheets, and cores in other disposable absorbent articles, such as wipes, catamenials, panty liners, pull-up diapers, adult incontinence products, and the like.

### Test Methods

Tensile Test

This section records the method that was used to measure the load in grams as a function of elongation until the sample fails (breaks), as reported in Table 1, above. The measurements were made using a constant rate of extension tensile tester, such as those produced by Instron® and the like. For each reported result, 10 Samples were tested, and the reported results are an average. Results are reported as the load in force per unit width (e.g. grams/in) at peak elongation and also as the elongation in percent at failure. (Peak and failure may or may not occur at the same point.) Testing was performed in a conditioned room controlled to 23±1° C. (73±2° F.) and 50±2% relative humidity.

Equipment and Equipment Selection Parameters:

Electronic Tensile Tester: Universal constant rate of extension tensile testing machine with computer interface, such as Instron 4200, 4300, 4500 or 5500 series. Instron Engineering Corp., Canton Mass., or MTS Sintech, Cary N.C. S1 frame or equivalent.

Load Cell: Chosen so that so that force results for the samples tested will be between 20 and 80% of the capacity of the load cell or load range used. (100 Newton load cell typical).

Jaws: Light duty jaws that are 2.54 cm (1.0 inch) by 2.54 cm (1.0 inch) flat face with line contact grips. Jaws can be air activated.

Precision Cutter: 2.54 cm (1.0 inch) wide precision cutter. Obtain from Thwing-Albert Instruments Co., Philadelphia, Pa. or equivalent.

Sample Preparation

Using the precision cutter, at least ten test specimens 2.54 cm (1.0 in) wide and 10.2 cm (4 in) long in the desired direction(s) (CD and/or MD) were cut from each web. For consistent results, ensure that the specimen is aligned in the desired test direction (CD or MD) when cutting the specimen and that the precision cutter is sharp so that the specimens are cut without any defects/tears being created along the specimen edges during cutting.

Equipment Preparation

A 100N load cell was chosen so that force results for the samples tested were between 20 and 80% of the capacity of the load cell. The tester was calibrated according to manufacturer's instructions. Gauge length was 5.1 cm (2.0 in). Crosshead speed was 50.8 cm/min (20 in/min).

A 5 gram pre-load was set. This procedure compensates for slack that may be present in the sample when loaded by finding the first point at which the measured load (force) exceeds the input pre-load (5 gf) and assigning an elongation value of zero (0) to this point.

Peak (maximum) load, and the elongation at break (failure) were recorded. Break sensitivity for real-time break detection was set to 50% (i.e. when the load has dropped by 50% of the measured peak load, the test was terminated). For calculations, the break point was defined as the first point after the peak load at which the load drops by ≧10% of the peak load (Break % Drop=10%—i.e. % elongation at break is defined as the point where Load=0.90×Peak Load).

Tensile Test

Testing was conducted in a conditioned room maintained at 23±1° C. (73±2° F.), 50±2% relative humidity. Each test sample was conditioned for a period of two hours prior to testing. One end of the specimen was clamped into the static jaw. The jaws were air activated and an appropriate operating pressure was determined based on the material to be tested to ensure no slippage occurred during testing. The specimen was aligned between the static and moving jaws and the other end was clamped into the moving jaw with enough tension to eliminate any slack, but less than 5 grams of force on the load cell. The tensile tester and data collection device were started simultaneously, and the instrument operated until the entire specimen failed (broke).

Calculations

The peak load in units of force (e.g. gf, N) was read from the resultant curve as the maximum load point on the curve and divided by the specimen width to calculate tensile at peak. The elongation at break (%) was obtained from the curve as the elongation corresponding to the point where the entire sample failed/broke. (Defined as the point where the load drops by 90%.).

$$Tensile at Peak ( gf \text{/} in or N \text{/} mm ) = \frac{Peak Load ( gf or N )}{\begin{matrix}Specimen Width \\ ( = 1 in or 25.4 mm )\end{matrix}} . \\ Elongation ( \% ) at Break = \frac{\begin{matrix}Total crosshead distance \\ traveled to failure ( cm )\end{matrix}}{Gauge Length ( 5.1 cm )} \times 100$$

Modified Tensile Test for Incrementally Stretched Nonwovens

For nonwovens that had been incrementally stretched (IS), the above-described method was modified to incorporate a zero gram pre-load. This allowed for the true extension of the material to be measured, since the initial extension of IS nonwovens takes place at essentially zero load.

Preparation of Samples

Samples were prepared as detailed herein with reference to FIG. 10. Because of the high extensibility of IS nonwovens, the sample length must be measured while the material is still on the roll, such as roll 38 shown in FIG. 1. As shown in FIG. 10, two lines 52 a distance of 5.1 cm (2.0 inch) apart were marked approximately in the center of the outer layer of roll 38. The outer layer was then carefully unwound off of the roll 38 and a Sample 54 was cut from the marked section, leaving at least 2.54 cm (1.0 inch) on either side of the marked lines for easier handling. Using the 2.54 cm (1.0 inch) wide precision cutter, CD and MD specimens were cut. Finished Samples 54 measured 10.16 cm (4.0 inch) CD×2.54 cm (1.0 inch) MD. Samples were conditioned at 23±1° C. (73±2° F.) and 50±2% relative humidity, for a minimum of 2 hours prior to testing.

Tensile Test

The IS nonwoven samples were clamped into the grip jaws with the marked lines 52 lined up with the bar line in the grip. The tensile test was then started and the material pulled to break. Peak load and elongation at break were calculated as described above in the test for base nonwovens.

Fuzz Level Test

This method is used as a quantitative prediction of the fuzz level of nonwoven or laminate materials and is accomplished by abrading a 4.3 in×1.6 in (11.0 cm×4.0 cm) piece of test material with 320 grit sandpaper and measuring the weight of loose microfibers collected per unit area. It is critical that the types of tape and sandpaper used in the test are not substituted from those described herein. Using tape with a different level of adhesive or sandpaper with a different grit can substantially alter the amount of microfibers removed from the sample being tested.

Apparatus

Sutherland Ink Rub Tester with 2 lb. Weight.

Aluminum oxide cloth 320 grit shop rolls made by Plymouth Coatings, (617) 447-7731. Can also be ordered through McMaster Carr, part number 468.7A51, (330) 995-5500.

Two sided tape, 3M #409—Netherland Rubber Company, (513) 733-1085.

Fiber Removal Tape, 3M #3187—Netherland Rubber Company, (513) 733-1085.

Analytical Balance (+/−0.0001 g)

Paper cutter

2200 g weight (metal) 170 mm×63 mm

Thick-style release paper liner

Cardboard—0.0445″ (1.13 mm) caliper

Materials Preparation

Measure and cut sandpaper pieces to 7.51 (19.0 cm) in length. Measure and cut pieces of 3M #3187 tape 6.5 inches (16.5 cm) in length, two tapes for each specimen. Fold under approximately 0.25 inch (0.6 cm) on each end of the tape to facilitate handling. Lay tape on thick-style release paper for easier handling. N=10 is the minimum number of specimens run per sample, with the average being reported in the data of Table 3.

Sample Preparation

Before handling or testing any of the materials, wash hands with soap and water to remove excess oils from hands. If this is not possible or the analyst prefers, latex gloves may be worn. Both of these techniques will help to eliminate the transfer of finger oils onto the samples and tapes. Lay out the Sample to be tested (i.e., the nonwoven) with the side to be tested facing down. Cut a piece of two-sided tape (3M #409) off roll. Remove backing, and apply the side of tape facing the backing to the Sample. Apply the two-sided tape across the Sample nonwoven lengthwise in the machine direction (MD). Replace the backing over the exposed tape. Using paper cutter, cut samples 11 cm MD and 4 cm CD, making sure whole rectangle is inside tape area.

Fuzz Test

1. Mount sandpaper on Sutherland Ink Rub Tester using a 2 lb. weight. Lay sandpaper on top of cardboard (a new piece is used for each test). Lay both on top of the 2 lb. weight. The sides will fold down into clips—make sure sandpaper and cardboard are flat.
2. Mount the specimen onto Sutherland Rub Tester platform, centering on metal plate. Place 2200 g weight on top of specimen for 20 seconds.
3. Attach metal plate and 2 lb. weight to Rub Tester.

4. Turn Rub Tester on. If the counter light is not illuminated press the reset button. Press the counter button to set the rub cycles to 20 times. Select Speed 1, the slow speed, (light is not illuminated) by using the Speed button. Press “Start”.
5. When Rub Tester has shut off, carefully remove the sandpaper/weight, being sure not to lose any of the loose microfibers (fuzz). In some cases, the microfibers will be attached to both the sandpaper and the surface of Sample nonwoven. Lay the weight upside down on the bench.
6. Weigh fiber removal tapes with release paper attached. Holding tape by its folded ends, remove release paper and set aside. Gently put the tape onto the sandpaper to remove all of the fuzz. Put back on release paper. Weigh and record the weight.
7. Hold another piece of the pre-weighted tape by its folded ends. Gently put the tape onto the surface of the rubbed nonwoven sample. Lay flat metal plate on top of tape. Lay 2200 g weight on top of metal plate for 20 seconds. Remove the tape with any loose fibers which may have stayed on the abraded Sample. The pre-weighted removal tape should be held by its folded ends to avoid fingerprints. Put back on release paper. Weigh and record the weight.
8. The fuzz weight is the sum of weight-increase of removal tapes.
   Calculations

Subtract the starting weight for each piece of tape from the ending weight. These numbers will be the weight of fuzz collected for each step of the method. For a given sample, add together the weight of fuzz collected from the sandpaper and the weight of fuzz collected from the abraded Sample nonwoven. This number will be the total weight of fuzz lost in grams. Multiply this value by 1000 to convert to milligrams (mg). To convert this measurement from absolute weight loss to weight loss per unit area, divide the total weight of fuzz by the size of the abraded area (44.0 cm²) for the unit of milligrams/square centimeter.

Bending Rigidity Test

The Kawabata Evaluation System (KES) is a measurement system designed for the comprehensive evaluation of fabric softness with surface, compression, bending, shear and tensile tests. While all of these properties are related to softness in some manner, it has been found that the bending rigidity of a nonwoven is one measure in particular that is directly related to consumer perceptions of softness. Therefore the Kawabata Bending Test (KES-FB2A) was used to evaluate bending rigidity as a quantitative measure of fabric stiffness. It is known that as stiffness decreases, the perception of softness increases.

Tests were run on 20 cm×20 cm samples using the “Knit High Sensitivity” measurement condition. Both MD and CD tests were performed, but only MD values reported in Table 3 since CD values of bending rigidity for IS materials are typically lower than the sensitivity of the instrument can distinguish. For bending rigidity testing, “bending rigidity in a machine direction (MD)” means bending rigidity tested with the bending occurring along an axis corresponding to a machine direction axis. The bending rigidity is defined by the slope of the curve of a plot of bending moment per unit length (M) versus bending curvature (K), and has units of g*cm²/cm.

1. A method for making a soft, fibrous material, said method comprising the steps of:
(a) providing a nonwoven fibrous web;
(b) consolidating said nonwoven fibrous web to achieve a consolidation area of at least X %;
(c) repeating step (b) at least one time to achieve a consolidation area of at least Y %, wherein Y>X; and
(d) stretching said nonwoven fibrous web.

2. The method of claim 1 wherein said method reduces the bending rigidity of the fibrous material in a machine direction axis of bending by at least about 20% and does not increase the fuzz removal value of said fibrous material.

3. The method of claim 2 wherein said bending rigidity is reduced by at least 40%.

4. The method of claim 3 wherein said bending rigidity is reduced by at least 60%.

5. The method of claim 1, wherein at least one of said consolidation steps comprises thermal bonding.

6. The method of claim 5, wherein said thermal bonding is by thermal point bonding via heated calendaring rollers.

7. The method of claim 6, wherein all of said consolidation steps comprises thermal bonding.

8. The method of claim 1, wherein Y is at least about 30%.

9. The method of claim 8, wherein Y is at least about 40%.

10. The method of claim 1, wherein said stretching is by incremental stretching.

11. A method for making a soft, fibrous material having a plurality of discrete, spaced apart relatively high basis weight regions, said relatively high basis weight regions being at least partially surrounded by at least one relatively low basis weight region, said method comprising the steps of:
(a) providing a nonwoven fibrous web having thermoplastic portions;
(b) consolidating said nonwoven fibrous web at a plurality of discrete, spaced apart bond sites to achieve a consolidation area of at least X %;
(c) repeating step (b) at least one time to achieve a consolidation area of at least Y %, wherein Y>X; and
(d) stretching said nonwoven fibrous web.

12. The method of claim 11, wherein Y is at least 30%.

13. The method of claim 12, wherein Y is at least about 40%.

14. The method of claim 11, wherein said stretching is by incremental stretching.

15. The method of claim 11 wherein said method reduces the bending rigidity of the fibrous material in a machine direction axis of bending by at least about 20% and does not increase the fuzz removal value of said fibrous material.

16. The method of claim 15 wherein said bending rigidity is reduced by at least 40%.

17. The method of claim 16 wherein said bending rigidity is reduced by at least 60%.

18. The method of claim 11, wherein at least one of said consolidation steps comprises thermal bonding.

19. The method of claim 18, wherein said thermal bonding is by thermal point bonding via heated calendaring rolls.

20. The method of claim 19, wherein all of said consolidation steps comprise thermal bonding.
